(19) United States
(12) Patent Application Publication
(10) Pub. No.: US 2025/0302023 A1
(43) Pub. Date: Oct. 2, 2025

(54) SPOOL AND SPINNING REEL

(71) Applicant: Shimano Inc., Osaka (JP)

(72) Inventors: Shu KUSUDA, Osaka (JP); Daichi NAKATA, Osaka (JP)

(21) Appl. No.: 19/034,121

(22) Filed: Jan. 22, 2025

(30) Foreign Application Priority Data
Mar. 29, 2024 (JP) 2024-055997

(51) Int. Cl. A01K 89/015

(52) U.S. Cl. CPC A01K 89/01931

(57) ABSTRACT

A spool for a spinning reel, includes a bobbin trunk and a front flange. The bobbin trunk has a front end and extends in an axial direction. The front flange is disposed on the front end of the bobbin trunk in the axial direction. The front flange includes a first wall portion disposed on an outer peripheral side of the bobbin trunk and extending radially outward, a first annular portion disposed further forward in the axial direction than an outermost diameter portion of the first wall portion and extending forward in the axial direction, and a second wall portion disposed on an outer peripheral side of the first annular portion and extending radially outward.

### CROSS-REFERENCE TO RELATED APPLICATIONS

This application claims priority to Japanese Patent Application No. 2024-055997, filed on Mar. 29, 2024. The entire disclosure of Japanese Patent Application No. 2024-055997 are hereby incorporated by reference.

### BACKGROUND

### Technical Field

The present disclosure relates to a spool and a spinning reel.

### Background Information

In a conventional spool an inclined surface is provided on an outer periphery of a front flange of the spool to control the releasing of a fishing line from the spool and to prevent backlash that occurs due to the fishing line being released all at once.

### SUMMARY

When fishing line is wound around a spinning reel, the fishing line can sometimes be wound around the spool in a slack state. It has been determined that when the fishing line is cast in this state, i.e., the fishing line wound around the spool in a slack state, the slack portion of the fishing line can be released and ride over the front flange, which can cause backlash (line entanglement).

An object of the present disclosure is to provide a spool for a spinning reel that can suppress the occurrence of backlash.

A spool according to one aspect of the present disclosure is a spool for a spinning reel, comprising a bobbin trunk and a front flange. The bobbin trunk extends in an axial direction. The front flange is arranged at a front end of the bobbin trunk in the axial direction. The front flange has a first wall portion, a first annular portion, and a second wall portion. The first wall portion is disposed on an outer peripheral side of the bobbin trunk and extends radially outward. The first annular portion is disposed further forward than an outermost diameter portion of the first wall portion and extends forward. The second wall portion extends radially outward with respect to the outer circumferential surface of the first annular portion.

According to this spool, it is possible to suppress, with the second wall portion, the release of fishing line that has been wound around the spool in a slack state from riding over the first annular portion at the time of casting. It is thereby possible to provide a spool for a spinning reel that can suppress the occurrence of backlash.

In a spool according to a second aspect in accordance with a first aspect of the present disclosure, the second wall portion extends flat in a radial direction perpendicular to the axial direction with respect to the outer circumferential surface of the first annular portion. In this case, it is possible to suppress, with the second wall portion, the release of a fishing line that has been wound around the spool in a slack state from riding over the first annular portion at the time of casting.

In a spool according to a third aspect in accordance with the first aspect of the present disclosure, the second wall has a slope that is inclined radially inward toward the front. In this case, it is possible to increase the axial-direction dimension of an area between the second wall portion and the outer circumferential surface of the first annular portion.

In a spool according to a fourth aspect in accordance with any one of the first to the third aspects of the present disclosure, the first annular portion of the spool has an outer circumferential surface that is flat in the axial direction and a diameter that is essentially the same as a line winding diameter corresponding to an upper limit of the amount of line that is wound around the bobbin trunk. In this case, the first annular portion can be used as an indicator for the amount of line that is wound around the bobbin trunk.

A spool according to a fifth aspect in accordance with any one of the first to the fourth aspects of the present disclosure further comprises an annular spool ring including a second wall portion. In this case, the second wall portion can be formed by the spool ring.

A spool according to a sixth aspect of the present disclosure is a spool for a spinning reel, comprising a bobbin trunk extending in an axial direction, a first wall portion extending radially outward from the bobbin trunk, a second wall portion disposed further forward than an outermost diameter portion of the first wall portion, and a retaining portion that retains a fishing line of a lower layer that is exposed from an outermost layer of the fishing line that is wound around the bobbin trunk in a layered manner so as not to ride over the second wall portion. According to this spool, it is possible to suppress, with the second wall portion, the release of a fishing line that has been wound around the spool in a slack state from riding over the second wall portion at the time of casting.

A spinning reel according to a seventh aspect of the present disclosure comprises the spool according to any one of the first to the sixth aspects.

According to the present disclosure, it is possible to provide a spool for a spinning reel that can suppress the occurrence of backlash.

### BRIEF DESCRIPTION OF THE DRAWINGS

FIG. 1 is a left side view of a spinning reel.

FIG. 2 is a side view of a spool.

FIG. 3 is a partial cross-sectional view of the spool.

FIG. 4 is a diagram for explaining a slack portion of a fishing line that is wound around a bobbin trunk.

FIG. 5 is a partial cross-sectional view of the spool.

FIG. 6 is a partial cross-sectional view of the spool.

FIG. 7 is a partial cross-sectional view of the spool.

FIG. 8 is a diagram for explaining a modified example of the spool.

FIG. 9 is a diagram for explaining a modified example of the spool.

FIG. 10 is a diagram for explaining a modified example of the spool.

FIG. 11 is a diagram for explaining a modified example of the spool.

### DETAILED DESCRIPTION

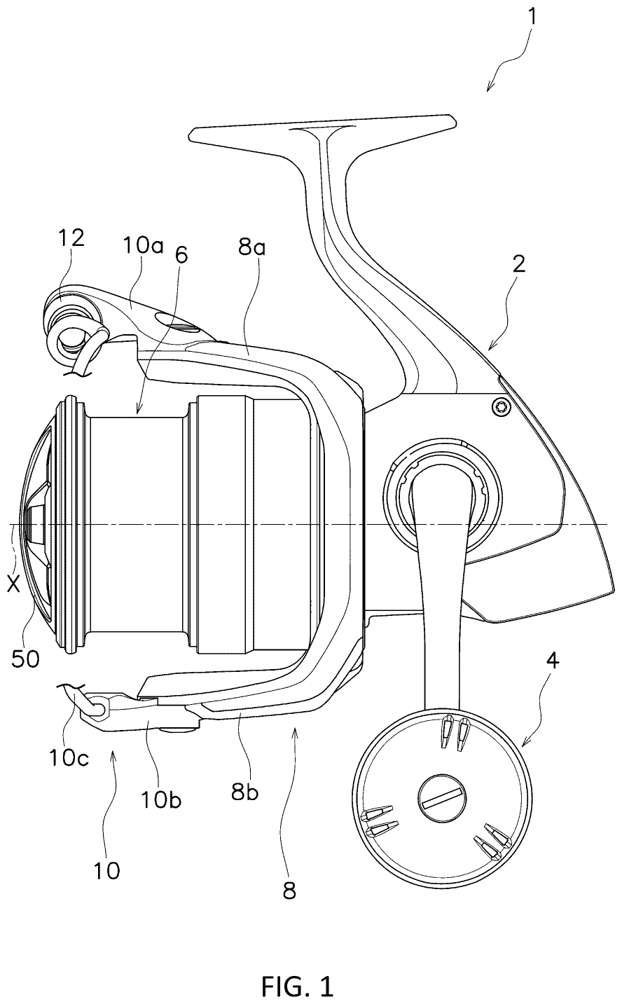

A spinning reel according to an embodiment will be described below with reference to the drawings. FIG. 1 is a side view of a spinning reel 1. As shown in FIG. 1, the spinning reel 1 comprises a reel body 2, a handle 4, a spool 6, a rotor 8, a bail arm 10, and a line roller 12.

In the following description, the direction in which the rotational axis X of the spool 6 extends is referred to as the axial direction, the direction perpendicular to the rotational axis X is referred to as the radial direction, and the direction around the rotational axis X is referred to as the circumferential direction. Of the radial direction, the direction approaching the rotational axis X is referred to as radially inward and the direction away from the rotational axis X is referred to as radially outward. In addition, the direction in which the fishing line is released at the time of casting is defined as the front, and the opposite direction is defined as the rear. In the present embodiment, the front-rear direction coincides with the axial direction.

As shown in FIG. 1, the reel body 2 has an internal space. The internal space of the reel body 2 houses mechanisms such as a rotor drive mechanism for driving the rotor 8 and an oscillating mechanism for evenly winding a fishing line around the spool 6.

The handle is supported by the reel body 2 so as to be rotatable. The handle 4 is disposed on the left side of the reel body 2. However, the handle 4 can be disposed on the right side of the reel body, if desired.

The spool 6 is attached to a spool shaft via a drag mechanism (not shown). The spool shaft extends in the front-rear direction. The spool shaft is supported by the reel body 2 so as to be movable in the front-rear direction.

A fishing line is wound around the outer periphery of the spool 6. The spool 6 integrally moves in the front-rear direction with the spool shaft in accordance with rotation of the handle 4. Details of the spool 6 will be described further below.

The rotor 8 is configured to wind the fishing line around the spool 6. As the handle 4 is rotated, the rotor 8 rotates about the rotational axis X via the rotor drive mechanism. The rotor 8 has a first rotor arm 8a and a second rotor arm 8b. The first rotor arm 8a and the second rotor arm 8b are arranged on the radially outer side of the spool 6. The second rotor arm 8b is disposed at a position facing the first rotor arm 8a in the radial direction.

The bail arm 10 is configured so as to be capable of swinging with respect to the rotor 8. The bail arm 10 is swingably attached to the respective distal ends of the first rotor arm 8a and the second rotor arm 8b.

The bail arm 10 has a first bail support member 10a, a second bail support member 10b, and a bail 10c. The first bail support member 10a is attached to the distal end of the first rotor arm 8a so as to be capable of swinging. The second bail support member 10b is attached to the distal end of the second rotor arm 8b so as to be capable of swinging. The bail 10c is fixed to the first bail support member 10a and the second bail support member 10b. The bail 10c extends in an arc shape between the first bail support member 10a and the second bail support member 10b.

The line roller 12 is disposed at the distal end of the first bail support member 10a. The line roller 12 guides the fishing line to the spool 6 in accordance with the rotation of the rotor 8.

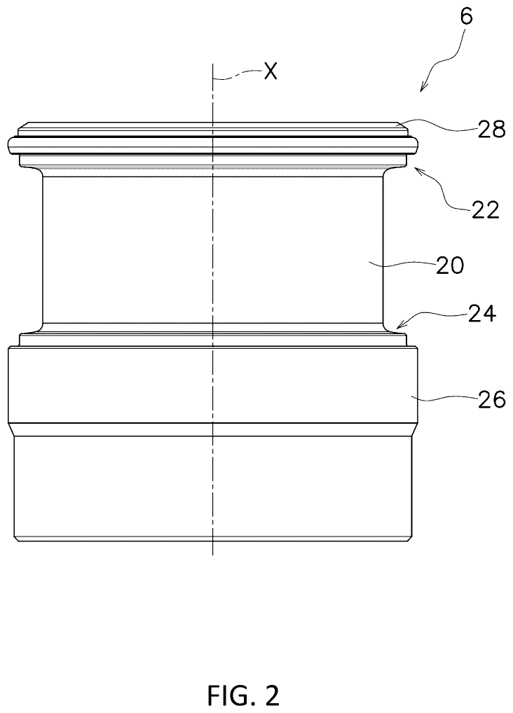

As shown in FIG. 2, the spool 6 has a bobbin trunk 20, a front flange 22, a rear flange 24, a skirt portion 26, and a fixing member 28. The bobbin trunk 20 extends in the axial direction. The fishing line is wound around the outer circumferential surface of the bobbin trunk 20.

The front flange 22 is disposed at the front end of the bobbin trunk 20. The front flange 22 extends radially outward from the front end of the bobbin trunk 20.

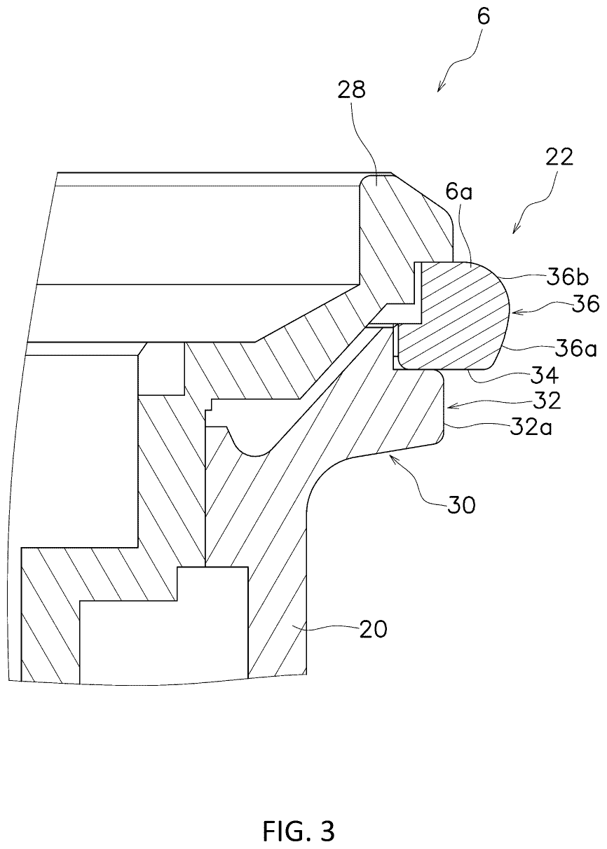

As shown in FIG. 3, the front flange 22 has a first wall portion 30, a first annular portion 32, a second wall portion 34 (one example of a retaining portion), and a second annular portion 36.

The first wall portion 30 is disposed on the outer peripheral side of the bobbin trunk 20. The first wall portion 30 extends radially outward from the front end of the bobbin trunk 20. The first wall portion 30 has a tapered shape and is inclined so that the radially outer side thereof is located further forward than the radially inner side. The first wall portion 30 is integrally formed with the bobbin trunk 20. The outermost diameter portion of the first wall portion 30 serves as a reference position for the amount of fishing line to be wound around the bobbin trunk 20. That is, the outer diameter of the front end portion of the fishing line that is wound around the bobbin trunk 20 is about the same as the outer diameter of the outermost diameter portion of the first wall portion 30.

The first annular portion 32 is disposed further forward than the outermost diameter portion of the first wall portion 30. The first annular portion 32 extends forward from the outermost diameter portion of the first wall portion 30. The first annular portion 32 is integrally formed with the first wall portion 30 and is seamlessly connected the first wall portion 30. The first annular portion 32 has an outer circumferential surface 32a extending flat in the axial direction. The first annular portion 32 has essentially the same diameter as the line winding diameter corresponding to the upper limit of the amount of line that can be wound around the bobbin trunk 20. The outer circumferential surface 32a of the first annular portion 32 is a cylindrical outer circumferential surface that extends along the axial direction. The outer circumferential surface 32a of the first annular portion 32 extends parallel to the axial direction in a cross-sectional view. A front-end corner of the outer circumferential surface 32a of the first annular portion 32 extends forward and radially inward. The outer circumferential surface 32a of the first annular portion 32 can be inclined radially inward or radially outward toward the front.

The second wall portion 34 is disposed in front of the first annular portion 32. The second wall portion 34 extends radially outward from the front end of the outer circumferential surface 32a of the first annular portion 32. The second wall portion 34 is sandwiched between the fixing member 28 and the first annular portion 32 of the front flange 22 in the axial direction.

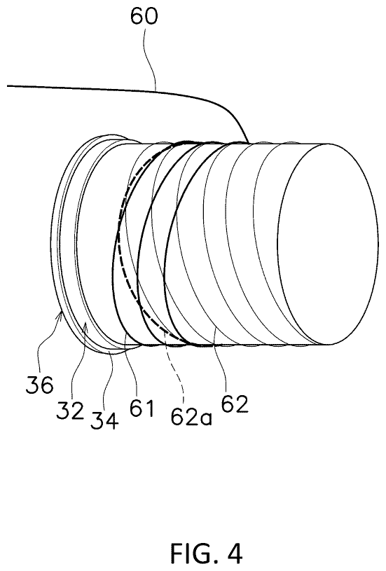

As shown schematically in FIG. 4, when the fishing line 60 is wound around the bobbin trunk 20 in a layered manner, the second wall portion 34 retains a lower layer 62 of the fishing line 60 that is exposed by an outermost layer 61 of the fishing line 60 so as not to ride over the first annular portion 32. More specifically, during casting, the first annular portion 32 and the second wall portion 34 retain a slack portion 62a of the lower layer 62, which is exposed from beneath the outermost layer 61 of the fishing line 60 wound around the bobbin trunk 20, such that the slack portion 62a does not ride over the first annular portion 32. As can be understood, the slack portion 62a is wound around the bobbin trunk 20 in a slack state. The left side in FIG. 4 is the front, which is the direction in which the fishing line is released at the time of casting.

The second wall portion 34 extends radially outward from the outer circumferential surface 32a of the first annular portion 32. The second wall portion 34 also extends radially outward from the front end of the outer circumferential surface 32a of the first annular portion 32. The second wall portion 34 is flat in the radial direction with respect to the outer circumferential surface 32a of the first annular portion 32. The second wall portion 34 can be inclined so that the radially outer side thereof is located in front of or behind the radially inner side.

The second annular portion 36 is disposed in front of the second wall portion 34. The second annular portion 36 extends forward from the outermost diameter portion of the second wall portion 34. The second annular portion 36 is integrally formed with the second wall portion 34. The second annular portion 36 has a first inclined portion 36a and a second inclined portion 36b. The first inclined portion 36a expands in diameter toward the front from the outermost diameter portion of the second wall portion 34. The second inclined portion 36b is disposed in front of the first inclined portion 36a. The second inclined portion 36b decreases in diameter toward the front. The second inclined portion 36b is seamlessly connected to the first inclined portion 36a. The dimension of the second inclined portion 36b in the axial direction is smaller than the dimension of the first inclined portion 36a in the axial direction.

In the present embodiment, the second wall portion 34 and the second annular portion 36 are formed by a spool ring 6a disposed between the fixing member 28 and the first annular portion 32 of the front flange 22. For this reason, the second wall portion 34 is configured as a separate body from the first annular portion 32. However, the second wall portion 34 can be formed integrally with the first annular portion 32.

The rear flange 24 is disposed at the rear end of the bobbin trunk 20. The rear flange 24 extends radially outward from the rear end of the bobbin trunk 20. The rear flange 24 is integrally formed with the bobbin trunk 20.

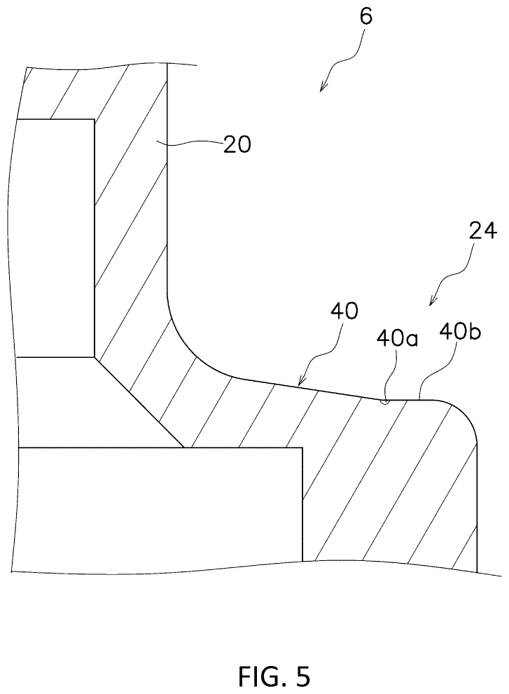

As shown in FIG. 5, the rear flange 24 has a wall portion 40. The wall portion 40 is disposed on the outer peripheral side of the bobbin trunk 20. The wall portion 40 extends radially outward from the rear end of the bobbin trunk 20. The wall portion 40 has a tapered shape and is inclined so that the radially outer side thereof is located rearward of the radially inner side.

The wall portion 40 has an indicator portion 40a and a flat portion 40b. The indicator portion 40a serves as an indicator for the wound amount of the lower end of the fishing line wound around the bobbin trunk 20. The indicator portion 40a is an annular step formed on the wall portion 40. The indicator portion 40a can have, for example, a groove shape. The indicator portion 40a has a shape that is recessed from the front to the rear. The outer diameter of the indicator portion 40a (distance from the rotational axis X to the indicator portion 40a) is about the same as the outer diameter of the first annular portion 32. The flat portion 40b extends from the indicator portion 40a radially outward in an annular shape. The flat portion 40b extends flat in the radial direction.

As shown in FIG. 2, the skirt portion 26 extends rearward from the outermost diameter portion of the rear flange 24. The skirt portion 26 has a cylindrical shape. The skirt portion 26 is integrally formed with the rear flange 24.

The fixing member 28 is screwed to the bobbin trunk 20 on the inner circumferential surface of the bobbin trunk 20. A portion of the fixing member 28 is disposed in front of the front flange 22. An adjustment knob 50 for adjusting the drag force of the drag mechanism is disposed on the inner circumferential portion of the fixing member 28.

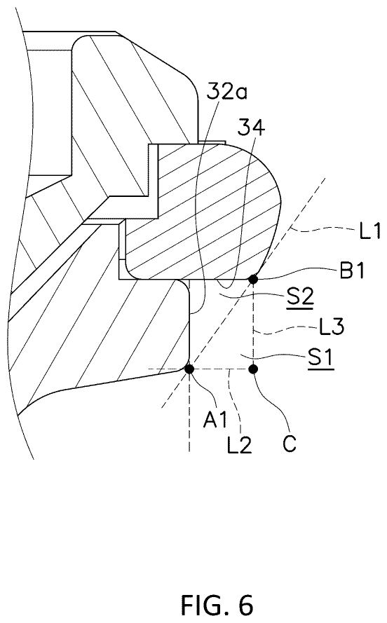

As shown in FIG. 6, when S1 is defined as a first region surrounded by a first straight line L1 that passes through point A1 and point B1, a second straight line L2 that passes through point A1 and point C, and a third straight line L3 that passes through point B1 and is parallel to the axial direction, and S2 is defined as a second region surrounded by the first straight line L1, the second wall portion 34, and the outer circumferential surface 32a of the first annular portion 32, it is preferable that the relational expression S2/S1≥X (X is a constant) is satisfied. X is preferably a large value. X is, for example, 1. By making the second region S2 larger than the first region S1, the second wall portion 34 can be expected to retain the slack portion 62a of the fishing line.

Point A1 is the outermost diameter portion of the first wall portion 30. Point B1 is the point of shortest-distance contact with the spool ring 6a when the fishing line is released from point A1, and, in this embodiment, is the outermost diameter portion of the second wall portion 34. Point C is the intersection of a straight line (second straight line L2) that passes through point A1 and that is parallel to the radial direction, and a straight line (third straight line L3) that passes through point B1 and that is parallel to the axial direction.

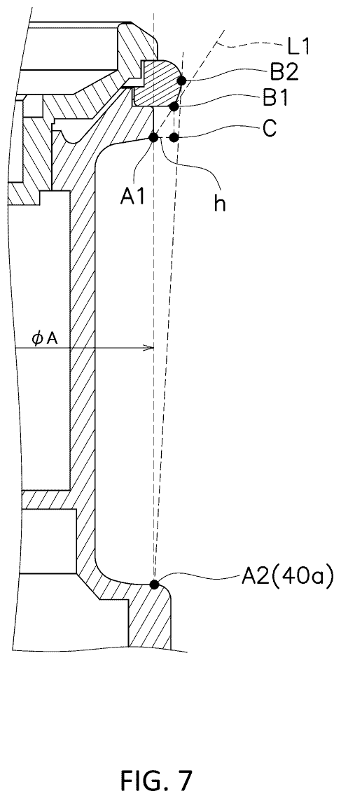

As shown in FIG. 7, when h is defined as the distance from point A1 to point C and od is defined as the diameter of the fishing line wound around the bobbin trunk 20, the second wall portion 34 can be expected to retain the slack portion 62a of the fishing line when the relational expression Y≥h/d≥X (X and Y are constants) is satisfied. For example, X is 1 and Y is 10. In FIG. 7, point A2 is approximately the location of the indicator portion 40a and the outermost diameter portion at the rear end of the fishing line when the fishing line is wound around the bobbin trunk 20. Point B2 is the point of first contact with the spool 6 when the fishing line is released from point A2 along the shortest path. Point B2 is the outermost diameter portion of the spool ring 6a, and, in this embodiment, the outermost diameter portion of the second annular portion 36 (outermost diameter portion of the first inclined portion 36a).

In the spinning reel 1 configured as described above, the release of the slack portion 62a of the fishing line, which is wound around the spool 6 in a slack state, can be prevented from riding over the first annular portion 32 at the time of casting by the second wall portion 34. It is thereby possible to provide the spinning reel 1 and the spool 6 for the spinning reel 1 that can suppress the occurrence of backlash. In the present embodiment, an example was shown in which X is 1 and Y is 10, but the values of X and Y were verified with a PE line, which is a braided line, and thus can be different when using monofilament lines such as nylon, fluorocarbon, and polyester.

### OTHER EMBODIMENTS

One embodiment of the present disclosure was described above, but the present disclosure is not limited to the above-described embodiment, and various modifications can be made without departing from the scope of the disclosure.

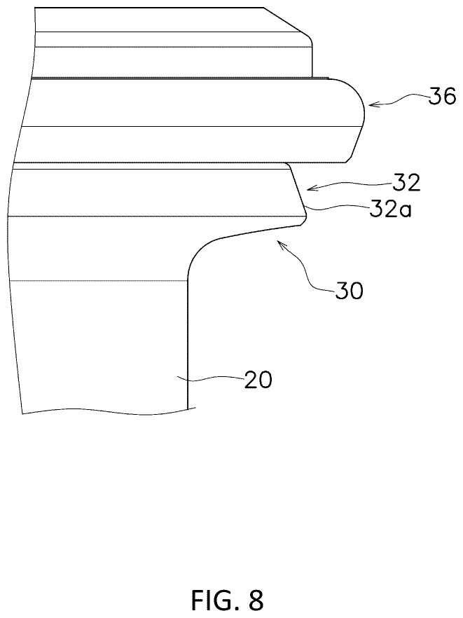

As shown in FIG. 8, the outer circumferential surface 32a of the first annular portion 32 can be inclined radially inward toward the front.

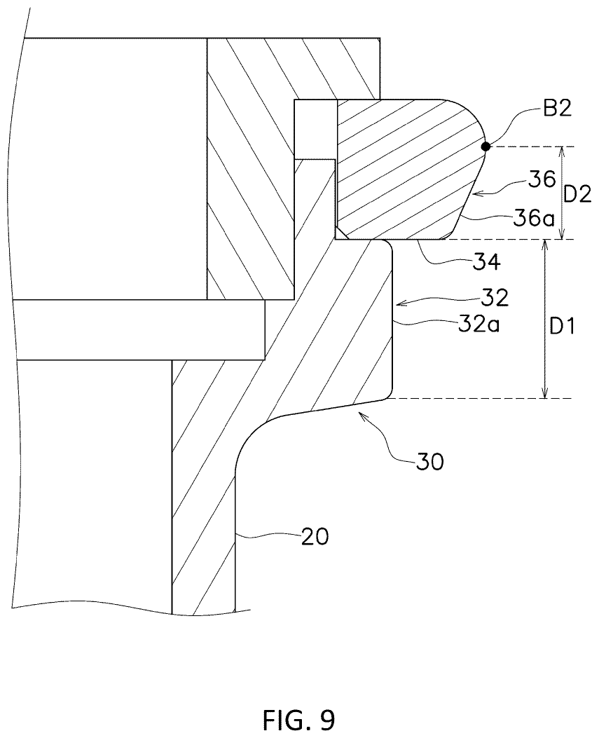

As shown in FIG. 9, a dimension D1 of the outer circumferential surface 32a of the first annular portion 32 in the axial direction can be larger than a dimension D2 from the second wall portion 34 to point B2 in the axial direction.

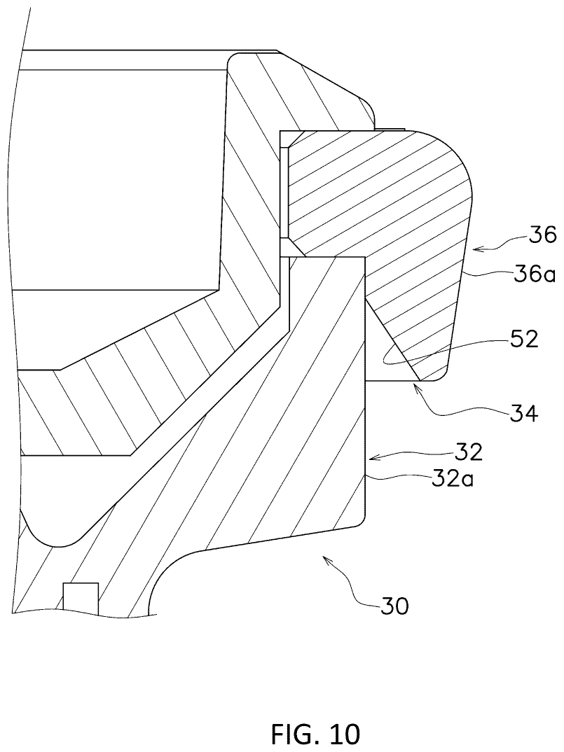

As shown in FIG. 10, the second wall portion 34 can have a slope 52 that is inclined radially inward toward the front. The second wall portion 34 has a shape covering a portion of the outer circumferential surface 32a of the first annular portion 32. As a result, the second region S2 can expand.

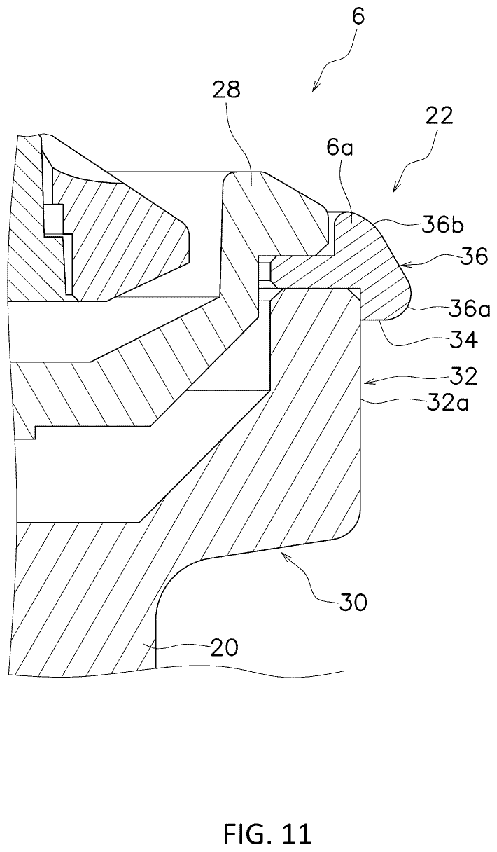

As shown in FIG. 11, the portion of the spool ring 6a in front of the second wall portion 34 can be inclined radially inward toward the front. The dimension of the second inclined portion 36b in the axial direction can be larger than the dimension of the first inclined portion 36a in the axial direction.

What is claimed is:

1. A spool for a spinning reel, comprising:
a bobbin trunk having a front end and extending in an axial direction; and
a front flange disposed on the front end of the bobbin trunk in the axial direction the front flange including
a first wall portion disposed on an outer peripheral side of the bobbin trunk and extending radially outward,
a first annular portion disposed further forward in the axial direction than an outermost diameter portion of the first wall portion and extending forward in the axial direction, and
a second wall portion disposed on an outer peripheral side of the first annular portion and extending radially outward.

2. The spool according to claim 1, wherein
the second wall portion is flat in a radial direction perpendicular to the axial direction with respect to an outer circumferential surface of the first annular portion.

3. The spool according to claim 1, wherein
the second wall portion has a slope that is inclined radially inward toward a front of the spool.

4. The spool according to claim 1, wherein
the first annular portion has an outer circumferential surface that is flat in the axial direction and a diameter that is essentially the same as a line winding diameter corresponding to an upper limit of an amount of line that is to be wound around the bobbin trunk.

5. The spool according to claim 1, further comprising
an annular spool ring including the second wall portion.

6. A spool for a spinning reel, comprising:
a bobbin trunk extending in an axial direction;
a first wall portion extending radially outward from the bobbin trunk;
a second wall portion disposed further forward in the axial direction than an outermost diameter portion of the first wall portion; and
a retaining portion configured to retain a fishing line of a lower layer that is exposed by an outermost layer of the fishing line wound around the bobbin trunk in a layered manner so as to prevent the lower layer from riding over the second wall portion.

7. A spinning reel, comprising the spool according to claim 1.
